(19) United States
(12) Patent Application Publication
(10) Pub. No.: US 2018/0215565 A1
(43) Pub. Date: Aug. 2, 2018

(54) SHEET FEEDING APPARATUS AND IMAGE FORMING APPARATUS

(71) Applicant: CANON KABUSHIKI KAISHA, Tokyo (JP)

(72) Inventor: Sho Ota, Kashiwa-shi (JP)

(21) Appl. No.: 15/848,413

(22) Filed: Dec. 20, 2017

(30) Foreign Application Priority Data
Jan. 31, 2017 (JP) 2017-015665

(51) Int. Cl. B65H 7/18; B65H 1/04; B65H 1/14; B65H 1/26; B65H 3/06; B65H 5/06; G03G 15/00

(52) U.S. Cl. CPC B65H 7/18; B65H 1/04; B65H 1/14; B65H 1/266; B65H 2404/16; B65H 5/062; G03G 15/6529; B65H 2801/06; B65H 3/0684

(57) ABSTRACT

A sheet feeding apparatus, including: a containing portion removable from the sheet feeding apparatus and including a tray; a pickup roller; a support portion configured to fall the pickup roller on the sheet stacked on the tray when a far-side end of the containing portion reaches a predetermined position; a detector configured to detect the containing portion; a motor configured to drive the pickup roller; and a controller configured to control an operation of feeding the sheet by the pickup roller, wherein, during a period in which the pickup roller is driven with the detector detecting the containing portion, the controller allows the operation when an amount of a load torque applied to a rotor of the motor is equal to or larger than a predetermined value and inhibits the operation when the amount of the load torque is smaller than the predetermined value.

### BACKGROUND OF THE INVENTION

### Field of the Invention

The present invention relates to a sheet feeding apparatus, which is applicable to an image forming apparatus such as a printer, and to an image forming apparatus including the sheet feeding apparatus.

### Description of the Related Art

Hitherto, in an image forming apparatus such as a copying machine, there is provided a sheet feeding apparatus including a sheet cassette and a feeding portion. The sheet cassette is configured to contain a plurality of sheets. The feeding portion is configured to pick up the sheets contained in the sheet cassette with a pickup roller and feed the sheets. In such a sheet feeding apparatus, a holding portion configured to hold the pickup roller has a function as a detector configured to detect a height of a surface of a topmost sheet on stack in the sheet cassette. Specifically, a photosensor configured to detect the height of the surface of the topmost sheet is provided in the sheet feeding apparatus. When the pickup roller held in contact with the topmost sheet reaches a height appropriate for feeding of the sheet, the holding portion configured to hold the pickup roller blocks light of the photosensor. That is, the holding portion configured to hold the pickup roller is used as a flag configured to detect that the pickup roller is positioned at the height appropriate for feeding of the sheet. Further, there has been known a configuration of causing the pickup roller to fall onto the sheet so as to bring the pickup roller into contact with the sheet in conjunction with an operation of inserting the sheet cassette to an image forming apparatus main body (Japanese Patent Application Laid-Open No. H09-226949).

In the sheet feeding apparatus having such a configuration, when the sheet cassette is inserted up to an appropriate position in a cassette-mounting portion, the pickup roller fall onto the sheet, and the holding portion is moved to a position of not blocking the light of the photosensor. After that, a surface on which the sheet is stacked (contained) lifts up so that the holding portion is raised up to a position of blocking the light of the photosensor. As a result, the pickup roller can feed the sheet at an appropriate height. Further, in the image forming apparatus main body, there is provided an insertion sensor configured to detect insertion of the sheet cassette to the sheet feeding apparatus. The insertion of the sheet cassette is detected in such a manner that a flag provided on a far side in an insertion direction of the sheet cassette blocks light of the insertion sensor constructed by a photosensor.

However, the above-mentioned configuration of causing the pickup roller to fall onto the sheet received in the sheet cassette in conjunction with the operation of inserting the sheet cassette has the following problem. When a timing to start the falling of the pickup roller in conjunction with the operation of inserting the sheet cassette is too early, the operation of inserting the sheet cassette is performed in the state in which the pickup roller and the sheet are held in contact with each other, resulting in skew feeding and bending of the sheet. In order to prevent such a problem, the timing to start the falling of the pickup roller needs to be set to a timing which is immediately before completion of the insertion of the sheet cassette.

Therefore, a position of the sheet cassette which triggers the falling of the pickup roller may need to be set to a position at which the sheet cassette is inserted to the far side with respect to a position at which the insertion sensor detects the insertion of the sheet cassette. In this case, there may occur such a situation that the insertion of the sheet cassette is detected, but the sheet cassette is not inserted up to the position which triggers the falling of the pickup roller.

Meanwhile, when the sheet cassette is inserted, an insertion load is generated due to an influence of a load and the like generated by a mechanism for causing the pickup roller to fall. There may be a case in which, when a user inserts the sheet cassette to the image forming apparatus main body, the user perceives that the sheet cassette has been inserted up to the appropriate position due to the influence of the insertion load, with the result that the sheet cassette is left unattended without being inserted up to the appropriate position. That is, there may occur such a situation that the insertion of the sheet cassette is detected, but the sheet cassette is not inserted up to the position which triggers the falling of the pickup roller. In this case, the pickup roller does not fall onto the sheet received in the sheet cassette, and hence the holding portion configured to hold the pickup roller blocks the light of the photosensor. Therefore, it is determined that the pickup roller is positioned at the height appropriate for feeding of the sheet, and the operation of feeding the sheet from the sheet cassette may be started. However, the pickup roller is not held in contact with the sheet, and hence the sheet may not be fed normally.

### SUMMARY OF THE INVENTION

The present invention has been made under such circumstances, and provides a sheet feeding apparatus, which prevents an operation of feeding a sheet from being performed in a state in which a pickup roller is not held in contact with the sheet.

In order to solve the above-mentioned problem, according to one embodiment of the present invention, there is provided a sheet feeding apparatus configured to feed a sheet, the sheet feeding apparatus comprising:

a containing portion including a tray on which the sheet is stacked, the containing portion being configured to be removable from the sheet feeding apparatus;

a pickup roller configured to be brought into abutment against and separated from the sheet stacked on the tray and configured to feed the sheet in a state in which the pickup roller abuts against the sheet;

a support portion configured to cause the pickup roller to fall so that the pickup roller is brought into abutment against the sheet contained in the tray when a far-side end of the containing portion reaches a predetermined position in the sheet feeding apparatus;

a detector provided upstream of the predetermined position in an insertion direction in which the containing portion is inserted, the detector being configured to detect the containing portion;

a motor configured to drive the pickup roller; and

a controller configured to control an operation of feeding the sheet by the pickup roller,

wherein, during a period in which the pickup roller is driven in a state in which the detector detects the containing portion, the controller allows the operation of feeding the sheet when an amount of a load torque that is applied to a rotor of the motor is equal to or larger than a predetermined value and the controller inhibits the operation of feeding the sheet when the amount of the load torque is smaller than the predetermined value.

Further features of the present invention will become apparent from the following description of exemplary embodiments with reference to the attached drawings.

### BRIEF DESCRIPTION OF THE DRAWINGS

FIG. 1 is a sectional view for illustrating a configuration of an image forming apparatus according to first and second embodiments of the present invention.

FIG. 2A, FIG. 2B, and FIG. 2C are views for illustrating an operation of inserting a sheet cassette to a sheet feeding apparatus according to the first and second embodiments.

FIG. 3 is a schematic view for illustrating a configuration of a feeding portion of the sheet feeding apparatus according to the first embodiment.

FIG. 4A and FIG. 4B are views for illustrating a configuration of a bouncing arm of the first and second embodiments.

FIG. 5 is a control block diagram of the sheet feeding apparatus according to the first embodiment.

FIG. 6 is a view for illustrating a relationship between a motor including two phases being an A phase and a B phase and a rotating coordinate system shown by a d-axis and a q-axis.

FIG. 7 is a block diagram for illustrating a drive control device for a stepper motor of the first and second embodiments.

FIG. 8 is a flowchart of a control sequence of sheet conveyance control of the first embodiment.

FIG. 9 is a schematic view for illustrating a conveyance sensor of the second embodiment.

FIG. 10 is a control block diagram of the sheet feeding apparatus according to the second embodiment.

FIG. 11 is a flowchart of a control sequence of a sheet conveyance control of the second embodiment.

### DESCRIPTION OF THE EMBODIMENTS

Now, a detailed description will be provided of embodiments of the present invention with reference to the accompanying drawings.

### First Embodiment

### [Configuration of Image Forming Apparatus]

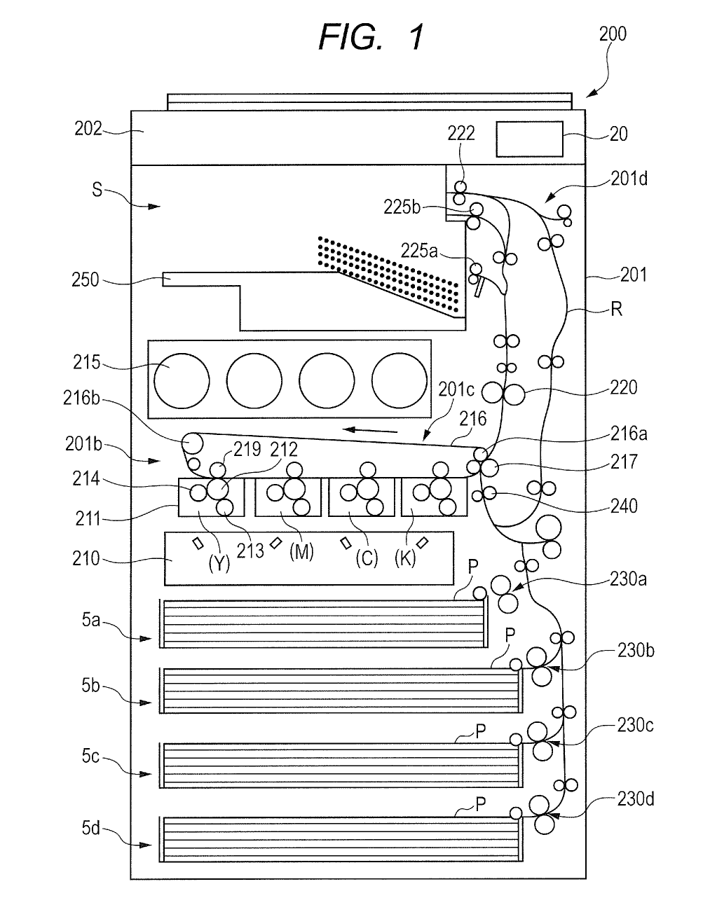

First, an image forming apparatus including a sheet feeding apparatus is described with reference to FIG. 1. As illustrated in FIG. 1, a full-color laser beam printer (hereinafter referred to as “printer”) 200 being an image forming apparatus includes an image forming apparatus main body (hereinafter also referred to as “apparatus main body”) 201 and an image reading apparatus 202.

The apparatus main body 201 includes sheet feeding apparatus 230a, 230b, 230c, and 230d. The sheet feeding apparatus 230a to 230d include sheet cassettes 5 (5a, 5b, 5c, and 5d) being containing portions configured to contain a sheet P, and the sheet cassettes 5a to 5d are removable from the sheet feeding apparatus 230 (230a, 230b, 230c, and 230d). The sheet cassettes 5a to 5d are able to contain sheets of different types, respectively. For example, A4-size plain paper is contained in the sheet cassette 5a, and A4-size thick paper is contained in the sheet cassette 5b. The sheet refers to an object on which an image is formed by the image forming apparatus, and the sheet encompasses, for example, paper, a resin sheet, cloth, an OHP sheet, and a label. When an image forming operation is performed, the sheet P is fed from a sheet feeding apparatus, which is designated among the sheet feeding apparatus 230a to 230d, to an image forming portion 201b. In the sheet feeding apparatus 230a to 230d, only the sheet cassette 5a has a different length in a right-and-left direction from those of the sheet cassettes 5b to 5d in FIG. 1, but configurations of feeding portions configured to feed the sheet P described later are the same.

The sheet cassettes 5a to 5d are pulled out from the sheet feeding apparatus 230a to 230d by being drawn toward a near side in FIG. 1, and are mounted to the sheet feeding apparatus 230a to 230d by being pushed toward a far side in FIG. 1. In the following, the sheet feeding apparatus 230a to 230d are collectively referred to as “sheet feeding apparatus 230” except for a case in which a specific sheet feeding apparatus is designated.

The image forming portion 201b employs a four-drum full-color method, and includes a laser scanner 210, and four process cartridges 211 configured to form toner images of four colors that are yellow (Y), magenta (M), cyan (C), and black (K) in the order from the left side in FIG. 1. Each of the process cartridges 211 includes a photosensitive drum 212 being a photosensitive member, a charging device 213 being a charging unit, a developing device 214 being a developing unit, and a cleaner (not shown) being a cleaning unit. Only the yellow process cartridge 211 on the most left side in FIG. 1 is denoted by a reference symbol. The configurations of other magenta, cyan, and black process cartridges 211 are the same as the configuration of the yellow process cartridge, and hence illustration of reference symbols thereof is omitted.

Further, the image forming portion 201b includes an intermediate transfer unit 201c. The intermediate transfer unit 201c includes an intermediate transfer belt 216 stretched over a drive roller 216a and a tension roller 216b. Further, the intermediate transfer unit 201c includes primary transfer rollers 219, which are arranged at positions opposed to the photosensitive drums 212 on an inner side of the intermediate transfer belt 216, and are held in abutment against the inner surface of the intermediate transfer belt 216. The intermediate transfer belt 216 is formed of a film-like member, and is held in abutment against each of the photosensitive drums 212. The intermediate transfer belt 216 is rotated by a drive roller 216a driven by a drive unit (not shown) in a direction indicated by the arrow in FIG. 1.

A positive transfer voltage is applied to the intermediate transfer belt 216 by the primary transfer rollers 219, and thus the toner images of the respective colors on the photosensitive drums 212, which have a negative polarity, are sequentially transferred onto the intermediate transfer belt 216 in a multi-layer manner. In this manner, a color image is formed on the intermediate transfer belt 216. A secondary transfer roller 217 is arranged at a position opposed to the drive roller 216a, and the color image formed on the intermediate transfer belt 216 is transferred onto the sheet P by the secondary transfer roller 217.

A fixing portion 220 is arranged on a downstream side of the secondary transfer roller 217 in a conveyance direction, and a delivery roller pair 225a, a delivery roller pair 225b, and a duplex reversing portion 201d being a reversing delivery portion are arranged on a downstream side of the fixing portion 220. The duplex reversing portion 201d includes a reversing roller pair 222 capable of rotating forward and backward, and a re-conveyance path R for re-conveying the sheet P having an image formed on a first surface thereof to the image forming portion 201b.

In the printer 200 described above, image information read by the image reading apparatus 202 or image information input from an external device such as a personal computer (PC) (not shown) is subjected to image processing to be converted into an electrical signal, and is transmitted to a laser scanner 210 of the image forming portion 201b. In the respective process cartridges 211 of the image forming portion 201b, surfaces of the photosensitive drums 212 are uniformly charged by the charging devices 213 so as to have predetermined polarity and potential. Then, laser beams, which correspond to image information, are emitted from the laser scanner 210, and thus electrostatic latent images of yellow, magenta, cyan, and black are formed on outer peripheral surfaces of the photosensitive drums 212 of the respective process cartridges 211. The electrostatic latent images formed on the outer peripheral surfaces of the photosensitive drums 212 of the respective process cartridges 211 are visualized by the developing devices 214 by causing toners to adhere to the outer peripheral surfaces of the photosensitive drums 212. That is, toner images are formed on the outer peripheral surfaces of the photosensitive drums 212. Then, the toner images formed on the outer peripheral surfaces of the photosensitive drums 212 are transferred onto the intermediate transfer belt 216 so as to be sequentially superimposed on one another by voltages applied to the primary transfer rollers 219. In this manner, the toner images are formed on the intermediate transfer belt 216.

Meanwhile, the sheet P, which is fed from any one of the sheet feeding apparatus 230a to 230d by a method described later passes through a registration roller pair 240, and is conveyed to a nip portion between the secondary transfer roller 217 and the intermediate transfer belt 216. Then, the toner images transferred onto the intermediate transfer belt 216 are transferred onto the sheet P. The sheet P having the toner images transferred thereonto is conveyed to the fixing portion 220, and is heated and pressurized, thereby fixing the toner images to the sheet P. After that, the sheet P having the toner images fixed thereto is delivered to a delivery space S by the delivery roller pair 225a, and is stacked on a delivery tray 250 provided in the delivery space S.

Further, an operation portion 20 includes an operation panel for input of data input or print instruction and a display portion for display of various information and display of alarm for a user.

[Configuration of Sheet Feeding Apparatus]

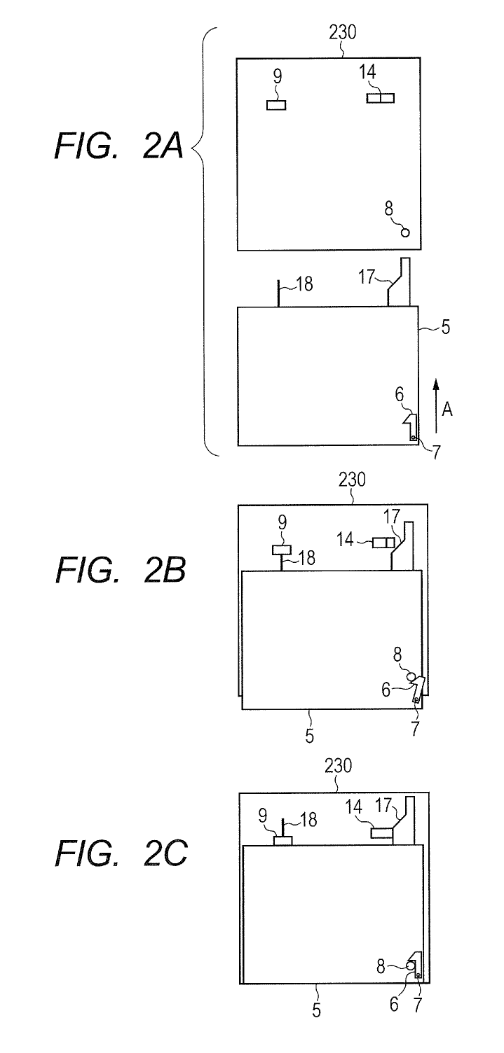

Subsequently, the sheet feeding apparatus 230 according to the first embodiment is described with reference to the drawings. FIG. 2A, FIG. 2B, and FIG. 2C are views for illustrating an operation of inserting the sheet cassette 5 to the sheet feeding apparatus 230. FIG. 2A, FIG. 2B, and FIG. 2C are views for illustrating a state of the sheet cassette 5 and the sheet feeding apparatus 230 when the printer 200 illustrated in FIG. 1 is viewed from above in FIG. 1. FIG. 2A is a view for illustrating a state in which the sheet cassette 5 is drawn from the sheet feeding apparatus 230. FIG. 2B is a view for illustrating a state in which the sheet cassette 5 is in the middle of being inserted into the sheet feeding apparatus 230 in a direction indicated by the arrow A (illustrated in FIG. 2A). FIG. 2C is a view for illustrating a state in which insertion of the sheet cassette 5 to the sheet feeding apparatus 230 has been completed, and the sheet cassette 5 has been mounted to the sheet feeding apparatus 230. The sheet P received in the sheet cassette 5 is fed in a rightward direction in FIG. 2A, FIG. 2B, and FIG. 2C.

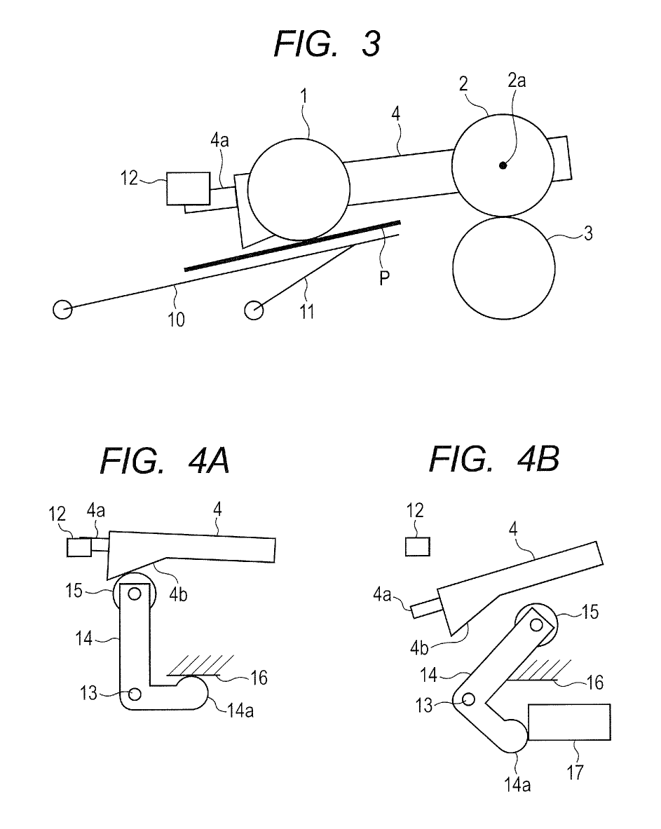

In FIG. 2A, in the sheet feeding apparatus 230, there are provided an insertion sensor 9 and a lock pin 8. The insertion sensor 9 is configured to detect insertion of the sheet cassette 5. The lock pin 8 is configured to position the sheet cassette 5 in the following manner. That is, when the sheet cassette 5 is inserted, a lock arm 6 provided to the sheet cassette 5 is caught on the lock pin 8. Further, in the sheet feeding apparatus 230, there is provided a bouncing arm 14 configured to cause the pickup roller 1 (see FIG. 3) to fall.

Meanwhile, in the sheet cassette 5, on the far side in an insertion direction (direction indicated by the arrow A in FIG. 2A), there are provided an inclined surface portion 17 (pivotal movement regulating member) and a flag 18. The flag 18 is configured to block light of the insertion sensor 9. The inclined surface portion 17 is configured to pivotally move the bouncing arm 14 so as to cause the pickup roller 1 to fall onto the sheet P received in the sheet cassette 5. Meanwhile, on the near side in the insertion direction of the sheet cassette 5, there is provided the lock arm 6 biased in a counterclockwise direction about a fulcrum shaft 7 by a spring (not shown). When the sheet cassette 5 is inserted up to an appropriate position in the sheet feeding apparatus 230, the lock arm 6 is engaged with the lock pin 8 provided to the sheet feeding apparatus 230 (FIG. 2C).

The insertion sensor 9 (detector) includes a photosensor (not shown). The photosensor includes a light emitting portion configured to emit light and a light receiving portion configured to detect the light from the light emitting portion. The insertion sensor 9 can detect the insertion of the sheet cassette 5 in such a manner that the flag 18 provided to the sheet cassette 5 blocks the light from the light emitting portion. The position of the sheet cassette 5 which causes the flag 18 to block the light from the light emitting portion is located on an upstream side in the insertion direction of the sheet cassette 5 with respect to the appropriate position being a predetermined position for the sheet cassette 5 being inserted. In this case, a state in which the flag 18 blocks the light of the photosensor of the insertion sensor 9 corresponds to an ON state of the insertion sensor 9, and a state in which the flag 18 does not block the light of the photosensor corresponds to an OFF state of the insertion sensor 9. When the sheet cassette 5 is inserted into the sheet feeding apparatus 230, the flag 18 provided to the sheet cassette 5 is inserted between the light emitting portion and the light receiving portion of the insertion sensor 9, and blocks light output from the light emitting portion of the photosensor provided to the insertion sensor 9. In this manner, the insertion sensor 9 detects insertion of the sheet cassette 5 (FIG. 2B and FIG. 2C).

Further, as illustrated in FIG. 2B and FIG. 2C, when the sheet cassette 5 is inserted toward the far side in the sheet feeding apparatus 230, the bouncing arm 14 is moved in a leftward direction in FIG. 2B and FIG. 2C along an inclined surface of the inclined surface portion 17. Consequently, regulation of a pick holder 4 (see FIG. 4B) by a rotation regulating portion 16 (see FIG. 4B) through intermediation of the bouncing arm 14 is released. As a result, the pickup roller 1 supported to the pick holder 4 falls onto a topmost sheet P placed on stack in the sheet cassette 5.

[Configuration of Feeding Portion]

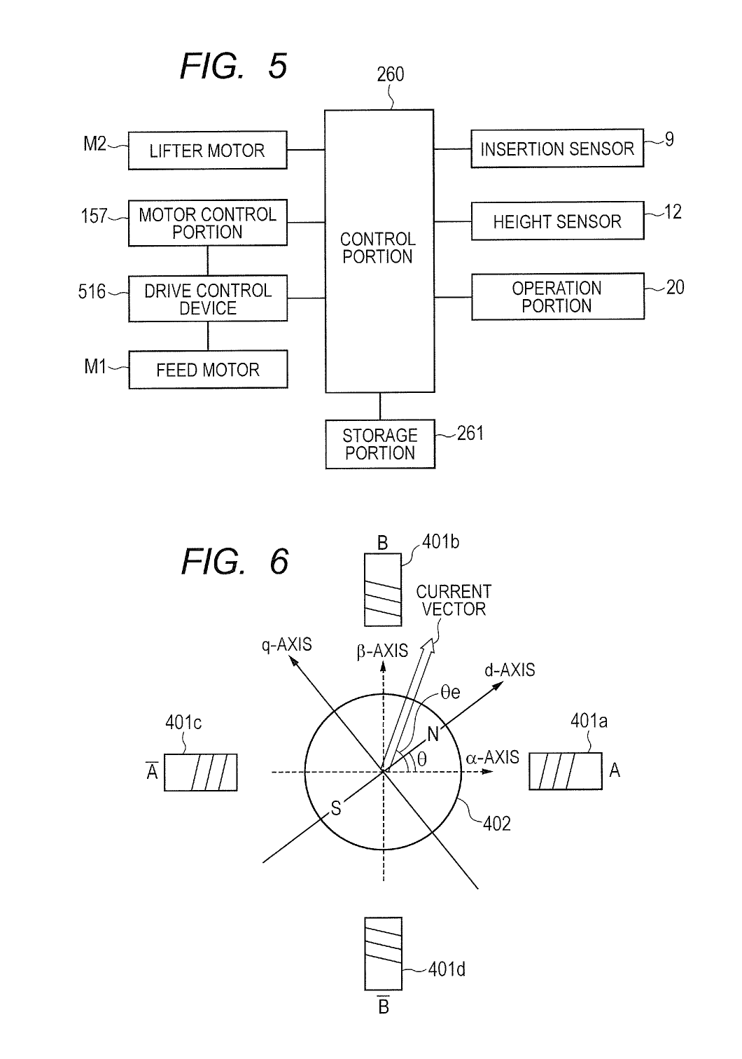

FIG. 3 is a schematic view for illustrating a configuration of the feeding portion configured to feed the sheet received in the sheet cassette 5 to the image forming portion 201b. FIG. 3 is an illustration of a configuration of a periphery of the feeding portion when the sheet feeding apparatus 230 illustrated in FIG. 2C is viewed in an upward direction from below in FIG. 2C. In the sheet cassette 5, there are provided a sheet stacking plate 10 and a lifter plate 11. The sheet stacking plate 10 is a tray which is axially supported to the sheet cassette 5 in a freely pivotable manner and configured to stack the sheet P. The lifter plate 11 is axially supported to the sheet cassette 5 in a freely pivotable manner, and is configured to push up an end portion of the sheet stacking plate 10 on a downstream side in a sheet-feed direction. The lifter plate 11 being a raising and lowering device is configured to perform a raising and lowering operation by being driven by a lifter motor M2 (see FIG. 5) described later.

The feeding portion includes the pickup roller 1, a feed roller 2, and a retard roller 3. The pickup roller 1 picks up the topmost sheet P on the sheet stacking plate 10, and the feed roller (also referred to as “conveyance roller”) 2 conveys the sheet P picked up by the pickup roller 1 to the image forming portion 201b. Further, the retard roller 3 is pressed by the feed roller 2, and returns a second or subsequent sheet P to the sheet cassette 5 side, thereby preventing overlapped sheet-feeding of the sheet P. The pickup roller 1 is pressed by a spring (not shown) in a direction toward the sheet P stacked on the sheet cassette 5, and is held by the pick holder 4 which is axially supported so as to be freely rotatable about a rotation axis 2a of the feed roller 2. The pickup roller 1, the feed roller 2, and the retard roller 3 are driven to rotate by a feed motor M1 (see FIG. 5) described later.

Further, a height sensor 12 (support portion detector) configured to detect a height of the sheets P placed on the sheet stacking plate 10 includes a photosensor (not shown). The photosensor includes a light emitting portion configured to emit light and a light receiving portion configured to detect the light from the light emitting portion. The sheet stacking plate 10 is pushed up by the lifter motor M2, and thus the pickup roller 1 held in contact with the topmost sheet P placed on stack in the sheet stacking plate 10 is also raised. Consequently, the pick holder 4 being a support portion that supports the pickup roller 1 is also raised, and a flag 4a provided at a distal end of the pick holder 4 is also raised. Then, the flag 4a provided to the pick holder 4 blocks the light from the light emitting portion of the height sensor 12, thereby being capable of detecting the height of the sheets P placed on the sheet stacking plate 10. In this case, a state in which the flag 4a blocks the light of the photosensor corresponds to an ON state of the height sensor 12, and a state in which the flag 4a does not block the light of the photosensor corresponds to an OFF state of the height sensor 12. The schematic view of FIG. 3 is an illustration of a state in which the sheet stacking plate 10 is raised, and in which the flag 4a provided at the distal end of the pick holder 4 that supports the pickup roller 1 blocks the light of the photosensor.

[Configuration of Bouncing Arm]

FIG. 4A and FIG. 4B are schematic views for illustrating a state of the bouncing arm 14 provided on the far side of the sheet feeding apparatus 230 in the insertion direction of the sheet cassette 5, and the pickup roller 1, the feed roller 2, and the retard roller 3 are omitted. FIG. 4A and FIG. 4B are illustrations of the configurations of the bouncing arm 14 and the feeding portion when the sheet feeding apparatus 230 illustrated in FIG. 2A and FIG. 2C is viewed in the upward direction from below in FIG. 2A and FIG. 2C. FIG. 4A is a schematic view for illustrating a state of the bouncing arm 14 illustrated in FIG. 2A, and FIG. 4B is a schematic view for illustrating a state of the bouncing arm 14 illustrated in FIG. 2C.

In the state in which the sheet cassette 5 is not inserted into the sheet feeding apparatus 230, the bouncing arm 14 which is axially supported by a bouncing arm shaft 13 in a pivotally movable manner is constantly biased by a spring (not shown) in the counterclockwise direction. The bouncing arm 14 is regulated by the rotation regulating portion 16 provided to the sheet feeding apparatus 230 so as not to rotate by a certain angle or more. Further, an abutment portion 14a, which is to be brought into contact with the inclined surface portion 17 of the sheet cassette 5, is formed at an end portion of the bouncing arm 14 on the rotation regulating portion 16 side, and a roller 15 is mounted to the other end portion of the bouncing arm 14. The roller 15 is held in abutment against an arm abutment portion 4b of the pick holder 4 to support the pick holder 4. The flag 4a provided at the distal end of the pick holder 4 blocks the light of the photosensor of the height sensor 12, and the height sensor 12 is in the ON state.

As described above, when the sheet cassette 5 is inserted into the sheet feeding apparatus 230, the bouncing arm 14 is rotated about the bouncing arm shaft 13 by the inclined surface portion 17 provided to the sheet cassette 5, and the state is changed. FIG. 4B is a schematic view for illustrating a state of the bouncing arm 14 when the sheet cassette 5 is inserted into the sheet feeding apparatus 230, and the sheet cassette 5 reaches the predetermined position at which the lock arm 6 is engaged with the lock pin 8 (FIG. 2C). When the sheet cassette 5 reaches the predetermined position, the inclined surface portion 17 reaches a position to be held in contact with the bouncing arm 14 (first position). As the result of the contact with the inclined surface portion 17, the bouncing arm 14 is rotated about the bouncing arm shaft 13 in a clockwise direction. Consequently, the roller 15 is moved from a surface of the arm abutment portion 4b of the pick holder 4 in a rightward direction in FIG. 4A and FIG. 4B. When the bouncing arm 14 is further rotated in the clockwise direction, the roller 15 reaches a position of being separated from the arm abutment portion 4b. As a result, the support of the pick holder 4 by the bouncing arm 14 is released, and thus the pick holder 4 pivotally moves about the rotation axis 2a of the feed roller 2 (FIG. 3) to fall in a downward direction in FIG. 4A and FIG. 4B (FIG. 4B). Consequently, the pickup roller 1 supported to the pick holder 4 falls onto the sheets P stacked on the sheet stacking plate 10. Consequently, the flag 4a provided at the distal end of the pick holder 4 is moved in the downward direction in FIG. 4A and FIG. 4B, and hence the height sensor 12 is changed from the ON state to the OFF state.

[Configuration of Control Portion of Sheet Feeding Apparatus]

FIG. 5 is a block diagram for illustrating a configuration of a control portion of the sheet feeding apparatus 230. A control portion 260 being a controller is connected to the insertion sensor 9, the height sensor 12, the operation portion 20, the lifter motor M2, a motor control portion 157, and a drive control device 516 (see FIG. 6). The motor control portion 157 is configured to control the drive control device 516 based on a command output from the control portion 260. The drive control device 516 is configured to control the feed motor M1 (drive unit) being a stepper motor based on a command output from the motor control portion 157.

The control portion 260 is configured to control drive of the lifter motor M2 and drive of the feed motor M1 via the motor control portion 157, and control the operation portion 20 based on information pieces of detection by the insertion sensor 9 and the height sensor 12. Further, the control portion 260 acquires information of a current value of a current supplied to the feed motor M1, which is acquired from the drive control device 516 described later, and calculates a load amount (load torque amount) of the feed motor M1. Then, the control portion 260 controls the drive of the feed motor M1 via the motor control portion 157 based on the calculated load amount. Further, the control portion 260 includes a storage portion 261 configured to store data and the like, which are necessary for control. The control portion 260 is herein described as the control portion of the sheet feeding apparatus 230, but may be, for example, a control portion of the printer 200.

[Insertion Failure of Sheet Cassette 5]

In the state in which the sheet cassette 5 is pulled out from the sheet feeding apparatus 230 (FIG. 2A), the roller 15 provided at the distal end of the bouncing arm 14 is held in abutment against the arm abutment portion 4b of the pick holder 4, and the pickup roller 1 is separated from the sheet P on the sheet stacking plate 10. At this time, the height sensor 12 is in the ON state (FIG. 4A). Meanwhile, in the state in which the sheet cassette 5 is inserted up to the appropriate position in the sheet feeding apparatus 230 (FIG. 2C), the abutment portion 14a of the bouncing arm 14 is held in abutment against the inclined surface portion 17 provided to the sheet cassette 5, and thus the bouncing arm 14 is rotated. As a result, the roller 15 is separated from the arm abutment portion 4b of the pick holder 4, and the pickup roller 1 supported to the pick holder 4 falls onto the sheet P placed on the sheet stacking plate 10. At this time, the height sensor 12 is in the OFF state (FIG. 4B).

Further, FIG. 2B is an illustration of a state in which the insertion of the sheet cassette 5 is stopped by a load, which is generated by a rotation of the bouncing arm 14 caused by the inclined surface portion 17 of the sheet cassette 5, when the sheet cassette 5 is in the middle of being inserted into the sheet feeding apparatus 230. At this time, the pick holder 4 is in the state as illustrated in FIG. 4A. Therefore, the pickup roller 1 supported to the pick holder 4 does not fall in the direction toward the sheet P placed on the sheet stacking plate 10, and the height sensor 12 is still in the ON state. Therefore, when the sheet-feeding operation is performed in the state as it has been, the sheet P is not fed normally.

[Drive Control for Feed Motor M1]

Next, vector control being drive control for the feed motor M1 is described with reference to the drawings. In the motor in the following description, a sensor such as a rotary encoder configured to detect a rotation phase of the rotor of the motor is not provided. However, the sensor such as the rotary encoder may be provided.

FIG. 6 is a diagram for illustrating a relationship between the feed motor being the stepper motor (hereinafter referred to as “motor”) M1 including two phases being an A phase (first phase) and a B phase (second phase), and a rotating coordinate system shown by the d-axis and the q-axis. In FIG. 6, the a-axis being an axis corresponding to a winding of the A phase, and the p-axis being an axis corresponding to a winding of the B phase are defined in a stationary coordinate system. Further, in FIG. 6, the d-axis is defined along a direction of a magnetic flux generated by a magnetic pole of a permanent magnet used in a rotor 402, and the q-axis is defined along a direction advanced by 90° from the d-axis in the counterclockwise direction (direction orthogonal to the d-axis). An angle formed between the a-axis and the d-axis is defined as θ, and the rotation phase of the rotor 402 is represented by the angle θ. In the vector control, the rotating coordinate system based on the rotation phase θ of the rotor 402 is used. Specifically, in the vector control, there are used a value of a q-axis component (torque current component) for causing the rotor to generate torque, which is a current component in the rotating coordinate system of a current vector corresponding to a drive current flowing through the winding, and a value of a d-axis component (excitation current component) that has an influence on the intensity of the magnetic flux passing through the winding.

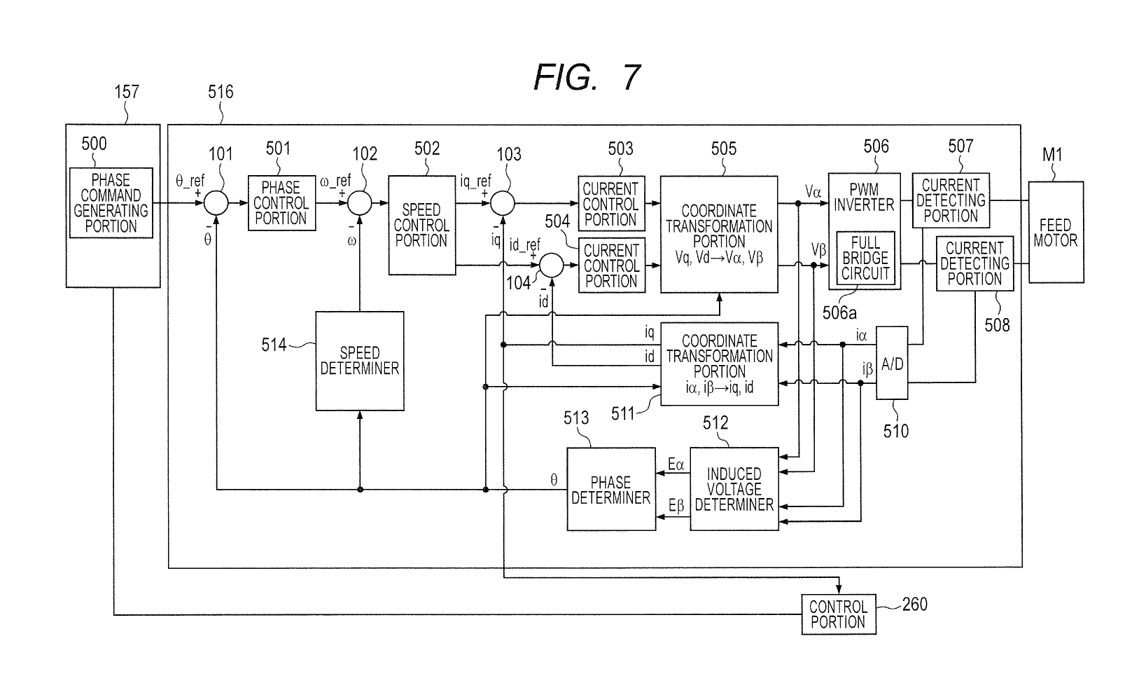

FIG. 7 is a control block diagram for illustrating a configuration of the drive control device 516 configured to control the drive of the motor M1. The drive control device 516 is constructed by at least one ASIC, and executes functions described below. The control portion 260 outputs a target phase of the rotor of the motor M1 to the motor control portion 157. The motor control portion 157 generates a phase command accompanied by temporal change in the phase command generating portion 500 in accordance with the target phase received from the control portion 260, and outputs the phase command to the drive control device 516. The drive control device 516 supplies a drive current in accordance with the phase command input from the motor control portion 157 to the winding of the motor M1, to thereby control the drive of the motor M1.

The drive control device 516 is constructed by three control loops including a phase control portion 501, a speed control portion 502, and current control portions 503 and 504. The drive control device 516 determines the rotation phase θ of the rotor of the motor M1 by a method described later, and performs the vector control based on the determination result. The phase command generating portion 500 generates a command phase θ_ref indicating the target phase of the rotor of the motor M1, and outputs the command phase θ_ref to the drive control device 516 with a predetermined time period. A subtractor 101 computes a difference between the rotation phase 6 of the rotor of the motor M1 and the command phase θ_ref, and outputs the difference to the phase control portion 501.

The phase control portion 501 outputs a speed command ω_ref based on proportional control (P), integral control (I), and derivative control (D) so that the difference output from the subtractor 101 becomes smaller. Specifically, the phase control portion 501 outputs the speed command ω_ref based on the P control, the I control, and the D control so that the difference output from the subtractor 101 becomes zero. The P control is a control method of controlling a value to be controlled based on a value proportional to a difference between the command value and the estimated value. Further, the I control is a control method of controlling the value to be controlled based on a value proportional to a time integral of the difference between the command value and the estimated value. Further, the D control is a control method of controlling the value to be controlled based on a value proportional to a temporal change of the difference between the command value and the estimated value. The phase control portion 501 in the first embodiment generates the speed command ω_ref based on the PID control, but the present invention is not limited thereto. For example, the phase control portion 501 may generate the speed command ω_ref based on the PI control. When the permanent magnet is used in the rotor, a d-axis current command value id_ref that has an influence on the intensity of the magnetic flux passing through the winding is normally set to zero, but the present invention is not limited thereto.

A subtractor 102 computes a difference between the speed command ω_ref being a command speed indicating a target speed of the rotor, which is output from the phase control portion 501, and a rotation speed ω determined by the speed determiner 514 by a method described later, and outputs the difference to the speed control portion 502. The speed control portion 502 generates and outputs a d-axis current command id_ref and a q-axis current command iq_ref based on the PID control so that the difference output from the subtractor 102 becomes smaller. Specifically, the speed control portion 502 generates and outputs the q-axis current command iq_ref and the d-axis current command id_ref based on the PID control so that the difference output from the subtractor 102 becomes zero. The speed control portion 502 in the first embodiment generates the q-axis current command iq_ref and the d-axis current command id_ref based on the PID control, but the present invention is not limited thereto. For example, the speed control portion 502 may generate the q-axis current command iq_ref and the d-axis current command id_ref based on the PI control. When the permanent magnet is used in the rotor, the d-axis current command value id_ref that has an influence on the intensity of the magnetic flux passing through the winding is normally set to zero, but the present invention is not limited thereto.

Currents flowing through windings of the A phase and the B phase of the motor 509 are detected by the current detecting portions 507 and 508 being current detectors, and then, are converted from analog values into digital values by an A/D converter 510. The current values of the drive currents, which are converted from the analog values into the digital values by the A/D converter 510, are represented by the following equations using a phase θe of the current vector illustrated in FIG. 6 as current values iα and iβ in the stationary coordinate system. The phase θe of the current vector is defined as an angle formed between the α-axis and the current vector. Further, I represents the magnitude of the current vector.

iα=I×cos θe (1)

iβ=I×sin θe (2)

Those current values iα and iβ are input to a coordinate transformation portion 511 and an induced voltage determiner 512.

The coordinate transformation portion 511 converts the current values iα and iβ into a current value iq of a q-axis current and a current value id of a d-axis current in the rotating coordinate system by the following equations.

id=cos θ×iα+sin θ×iβ (3)

iq=−sin θ×iα+cos θ×iβ (4)

The coordinate transformation portion 511 outputs the current value iq to a subtractor 103 and the control portion 260. Further, the coordinate transformation portion 511 outputs the current value id to a subtractor 104.

The subtractor 103 computes a difference between the q-axis current command iq_ref indicating a target value of the torque current component and the current value iq, and outputs the difference to the current control portion 503. Further, the subtractor 104 computes a difference between the d-axis current command id_ref indicating a target value of the excitation current component and the current value id, and outputs the difference to the current control portion 504. The current control portion 503 generates a drive voltage Vq based on the PID control so that the difference thus input becomes smaller. Specifically, the current control portion 503 generates the drive voltage Vq so that the difference thus input becomes zero, and outputs the drive voltage Vq to the coordinate transformation portion 505.

Further, the current control portion 504 generates a drive voltage Vd based on the PID control so that the difference thus input becomes smaller. Specifically, the current control portion 504 generates the drive voltage Vd so that the difference thus input becomes zero, and outputs the drive voltage Vd to the coordinate transformation portion 505. The current control portions 503 and 504 in the first embodiment generate the drive voltages Vq and Vd based on the PID control, but the present invention is not limited thereto. For example, the current control portions 503 and 504 may generate the drive voltages Vq and Vd based on the PI control.

The coordinate transformation portion 505 reversely converts the drive voltages Vq and Vd in the rotating coordinate system into drive voltages Vα and Vβ in the stationary coordinate system by the following equations.

Vα=cos θ×Vd−sin θ×Vq (5)

Vβ=sin θ×Vd+cos θ×Vq (6)

The coordinate transformation portion 505 reversely converts the drive voltages Vq and Vd in the rotating coordinate system into the drive voltages Vα and Vβ in the stationary coordinate system, and then, outputs the drive voltages Vα and Vβ to a PWM inverter 506 and the induced voltage determiner 512.

The PWM inverter 506 includes a full bridge circuit 506a. The full bridge circuit 506a is driven by a PWM signal based on the drive voltages Vα and Vβ input from the coordinate transformation portion 505. As a result, the PWM inverter 506 generates drive currents iα and iβ in accordance with the drive voltages Vα and Vβ, and supplies the drive currents iα and iβ to the windings of the respective phases of the motor M1, to thereby drive the motor M1.

Next, a determination method for the rotation phase θ is described. The rotation phase θ of the rotor is determined using values of the induced voltages Eα and Eβ that are induced through the rotation of the rotor by the windings of the A phase and the B phase of the motor M1. The values of the induced voltages are determined (calculated) by the induced voltage determiner 512. Specifically, the induced voltages Eα and Eβ are determined by the following equations using the current values iα and iβ input from the A/D converter 510 to the induced voltage determiner 512, and the drive voltages Vα and Vβ input from the coordinate transformation portion 505 to the induced voltage determiner 512.

Eα=Vα−R×iα−L×diα/dt (7)

Eβ=Vβ−R×iβ−L×diβ/dt (8)
R: winding resistance, L: winding reactance

In this case, values of the winding resistance R and the winding reactance L are stored in the induced voltage determiner 512 in advance.

The induced voltages Eα and Eβ thus calculated are output to the phase determiner 513. The phase determiner 513 determines the rotation phase 9 of the rotor of the motor M1 based on the induced voltages Eα and Eβ input from the induced voltage determiner 512 by the following expression (9). ATAN refers to an arc tangent computing function.

θ=ATAN (−Eβ/Eα) (9)

In the first embodiment, the phase determiner 513 determines the rotation phase θ through computing based on the expression (9), but the present invention is not limited thereto. For example, the phase determiner 513 may determine the rotation phase θ by referring to a table showing relationships between the induced voltage Eα and the induced voltage Eβ and rotation phases θ corresponding to the induced voltage Eα and the induced voltage Eβ, which is stored in the phase determiner 513 in advance. The rotation phase θ of the rotor, which is obtained in the above-mentioned manner, is output to the subtractor 101, the coordinate transformation portions 505 and 511, and the speed determiner 514.

The speed determiner 514 determines the rotation speed ω of the rotor of the motor M1 using the rotation phase θ input from the phase determiner 513 by the following expression (10).

ω=dθ/dt (10)

The determined rotation speed ω is output to the speed control portion 502. The drive control device 516 performs the controls described above repeatedly.

The control portion 260 determines the load amount (load torque amount) of the motor M1 based on the q-axis current value iq thus input. Specifically, the control portion 260 determines the load amount (torque amount) of the motor M1 based on a table, which is stored in the storage portion 261 in advance, and associates the q-axis current value iq and the torque amount of the motor M1, which corresponds to the q-axis current value iq, with each other.

As described above, the drive control device 516 in the first embodiment performs the vector control of controlling the current value in the rotating coordinate system so that the difference between the command phase θ_ref and the rotation phase θ becomes smaller. Through the vector control, it is possible to suppress step-out of the motor, increase in noise of the motor due to surplus torque, and increase in power consumption.

[Control Sequence at Time of Inserting Sheet Cassette]

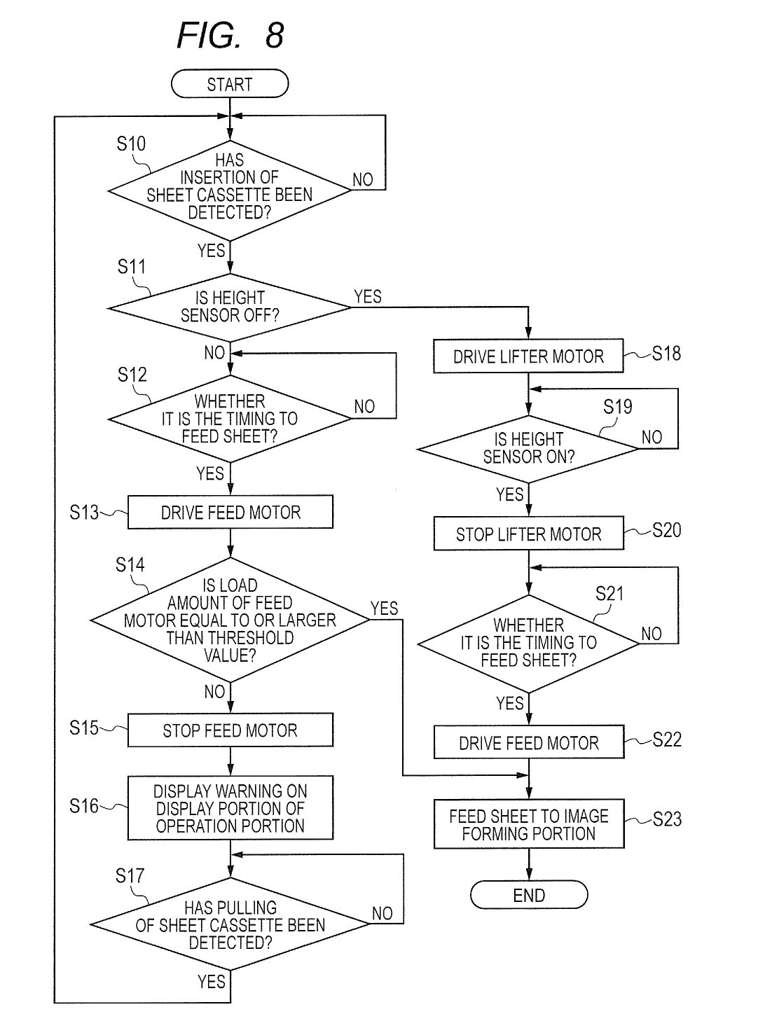

Next, a description will be provided of a control sequence at the time when a user inserts the sheet cassette to the sheet feeding apparatus 230. FIG. 8 is a flowchart for illustrating the control sequence at the time when the sheet cassette 5 is inserted into the sheet feeding apparatus 230. The processes illustrated in FIG. 8 are activated when an instruction to start the image forming operation is given, and are executed by the control portion 260.

In Step (hereinafter referred to as “S”) 10, when the insertion sensor 9 is in the ON state, the control portion 260 causes the process to proceed to S11. Meanwhile, when the insertion sensor is in the OFF state in S10, the control portion 260 repeats the process in S10.

When the height sensor 12 is in the ON state in S11, the control portion 260 causes the process to proceed to S12. After that, when it is a timing to feed the sheet in S12, the control portion 260 drives the motor M1 via the motor control portion 157 in S13, to thereby start rotation of the pickup roller 1, the feed roller 2, and the retard roller 3. The timing to feed the sheet is set in advance by an operation sequence of the image forming operation.

In S14, the control portion 260 determines an amount of torque applied to the rotor of the motor M1 during a period in which the pickup roller 1 is driven to rotate based on the current value iq acquired from the drive control device 516 configured to control the drive of the motor M1. Specifically, the control portion 260 determines the torque amount based on the table stored in the storage portion 261 described above. When the determined torque amount is equal to or larger than a threshold value (equal to or larger than a predetermined value), the control portion 260 causes the process to proceed to S23 so as to allow the operation of feeding the sheet and continue the feeding of the sheet. Meanwhile, when the determined torque amount is smaller than the threshold value, the control portion 260 causes the process to proceed to S15 so as to inhibit the operation of feeding the sheet. In this case, a torque amount having the threshold value being the predetermined value is corresponds to T (load amount T), and a torque amount of the motor M1 at the time when the pickup roller 1 is not held in contact with the sheet P (hereinafter referred to as “drag torque amount”) corresponds to T0. Further, a torque amount of the motor M1 at the time when the pickup roller 1 is held in contact with the sheet P (hereinafter referred to as “conveyance torque amount”) corresponds to Ts. In the first embodiment, the torque amount T having the threshold value is set so that a relational expression of T0≤T<Ts holds for the three torque amounts T, T0, and Ts. Further, a gear ratio from the motor M1 to the pickup roller 1 corresponds to Rg. A radius of the pickup roller 1 corresponds to ra. A friction coefficient between the sheets P corresponds to up. An abutment pressure of the pickup roller 1 against the sheet P corresponds to Na. A relationship represented by the following expression (11) holds between the conveyance torque amount Ts and the drag torque amount T0.

Ts−T0=μp×Na×ra/Rg (11)

Next, in S15, the control portion 260 stops the drive of the motor M1 via the motor control portion 157, to thereby stop the rotation of the pickup roller 1, the feed roller 2, and the retard roller 3. Then, in S16, the control portion 260 displays (displays an alarm), on the display portion of the operation portion 20, information indicating that the sheet cassette 5 is not properly inserted into the sheet feeding apparatus 230 (the sheet cassette 5 is not inserted up to the appropriate position) (insertion failure). After that, In S17, when the insertion sensor 9 is in the OFF state, the control portion 260 causes the process to return S10. Meanwhile, when the insertion sensor 9 is in the OFF state in S17, the control portion 260 repeats the process in S17.

Meanwhile, when the height sensor 12 is in the OFF state in S11, the control portion 260 causes the process to proceed to S18. In S18, the control portion 260 drives the lifter motor M2 to raise the lifter plate 11 so as to raise the pickup roller 1 provided above the sheet P stacked on the sheet stacking plate 10 of the sheet cassette 5 up to a predetermined position for feeding the sheet P. After that, when the height sensor 12 is in the ON state in S19, the control portion 260 stops the drive of the lifter motor M2 in S20, to thereby stop the raise of the lifter plate 11.

Next, when it is the timing to feed the sheet received in the sheet cassette 5 in S21, the control portion 260 drives the motor M1 via the motor control portion 157 in S22, to thereby start the rotation of the pickup roller 1, the feed roller 2, and the retard roller 3. Then, in S23, the control portion 260 executes an operation sequence for feeding the sheet P to the image forming portion. As a result, the sheet P is fed to the image forming portion.

As described above, the sheet-feeding operation is controlled by the control portion 260 based on the load state of the motor M1. As a result, the sheet-feeding operation can be prevented from being started in the state in which the pickup roller 1 is not held in contact with the sheet P received in the sheet cassette 5. That is, occurrence of the state in which the sheet P is not fed normally, which is caused due to the situation that the sheet cassette 5 is not inserted up to the appropriate position in the sheet feeding apparatus 230, can be prevented. Further, the display of an alarm on a display screen of the operation portion can prompt a user to perform an insertion-pull operation of the sheet cassette to eliminate the insertion failure of the sheet cassette. The processes in the flowchart illustrated in FIG. 8 may be executed only when the sheet-feeding operation is first performed after the sheet cassette 5 is inserted into the sheet feeding apparatus 230 or executed every time the sheet-feeding operation is performed.

As described above, according to the first embodiment, the operation of feeding the sheet can be prevented from being performed in the state in which the pickup roller is not held in contact with the sheet.

### Second Embodiment

In the first embodiment, after the timing to feed the sheet, the load of the motor M1 is determined, and whether or not the sheet cassette 5 is inserted up to the appropriate position in the sheet feeding apparatus 230 is detected based on the determination result. In the second embodiment, a description will be provided of a method of detecting whether or not the sheet cassette 5 is inserted up to the appropriate position in the sheet feeding apparatus 230 before the timing to feed the sheet. The configurations of the printer 200 and the sheet feeding apparatus 230 are the same as those of the first embodiment. In the following, the same reference symbols are used for the same configurations as those of the first embodiment, and description thereof is omitted herein.

[Conveyance Sensor]

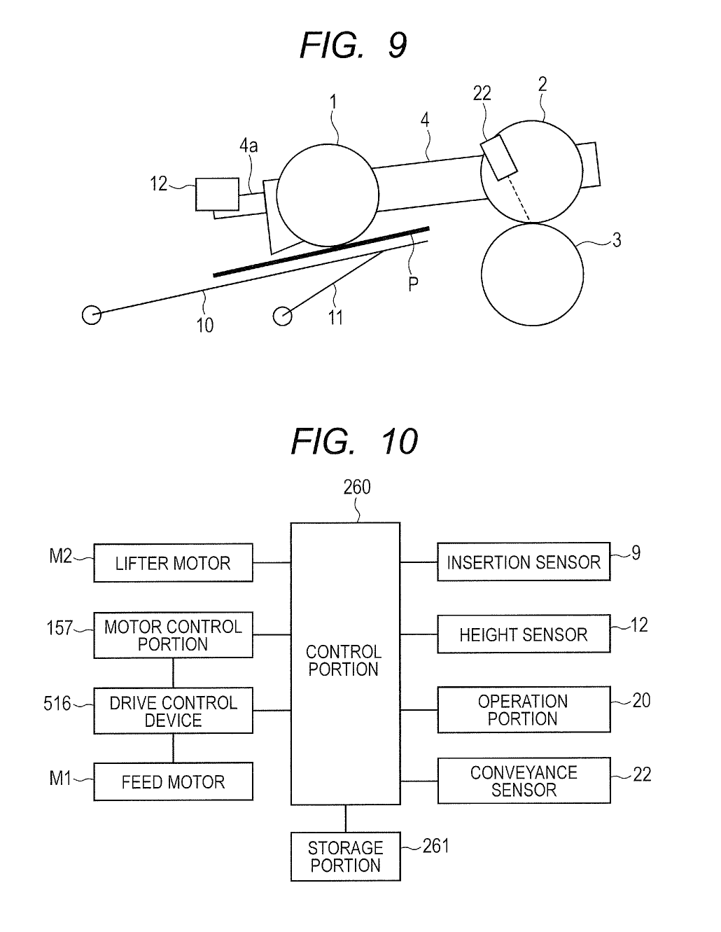

FIG. 9 is a schematic view for illustrating a configuration of a feeding portion of the second embodiment, which is configured to feed the sheet P received in the sheet cassette 5 to the image forming portion 201b. FIG. 9 is an illustration of a configuration of a periphery of the feeding portion when the sheet feeding apparatus 230 illustrated in FIG. 2C is viewed in the upward direction from below in FIG. 2C. FIG. 9 is different from FIG. 3 of the first embodiment in that a conveyance sensor 22 is added. However, other configurations are the same as the configurations of FIG. 3, and hence description thereof is omitted.

The conveyance sensor 22 is provided in the vicinity of the feed roller 2 provided on the downstream side of the pickup roller 1 in a feed direction of the sheet P. The conveyance sensor 22 includes a light emitting portion configured to emit light and a light receiving portion configured to detect the light. The light receiving portion detects that the sheet P passes through a nip portion of the feed roller 2 by detecting light emitted from the light emitting portion and reflected from the sheet P. A state in which the light receiving portion detects the light reflected from the sheet P is defined as an ON state, and a state in which the light receiving portion does not detect the reflected light is defined as an OFF state.

[Configuration of Control Portion of Sheet Feeding Apparatus]

FIG. 10 is a block diagram for illustrating a configuration of the control portion 260 of the sheet feeding apparatus 230 according to the second embodiment. FIG. 10 is different from FIG. 5 of the first embodiment in that the conveyance sensor 22 described above is added. However, other configurations are the same as the configurations of the first embodiment, and hence description thereof is omitted. The control portion 260 controls the drive of the motor M1 via the motor control portion 157 in accordance with a detection result of the conveyance sensor 22.

[Control Sequence of Sheet Conveyance Control]

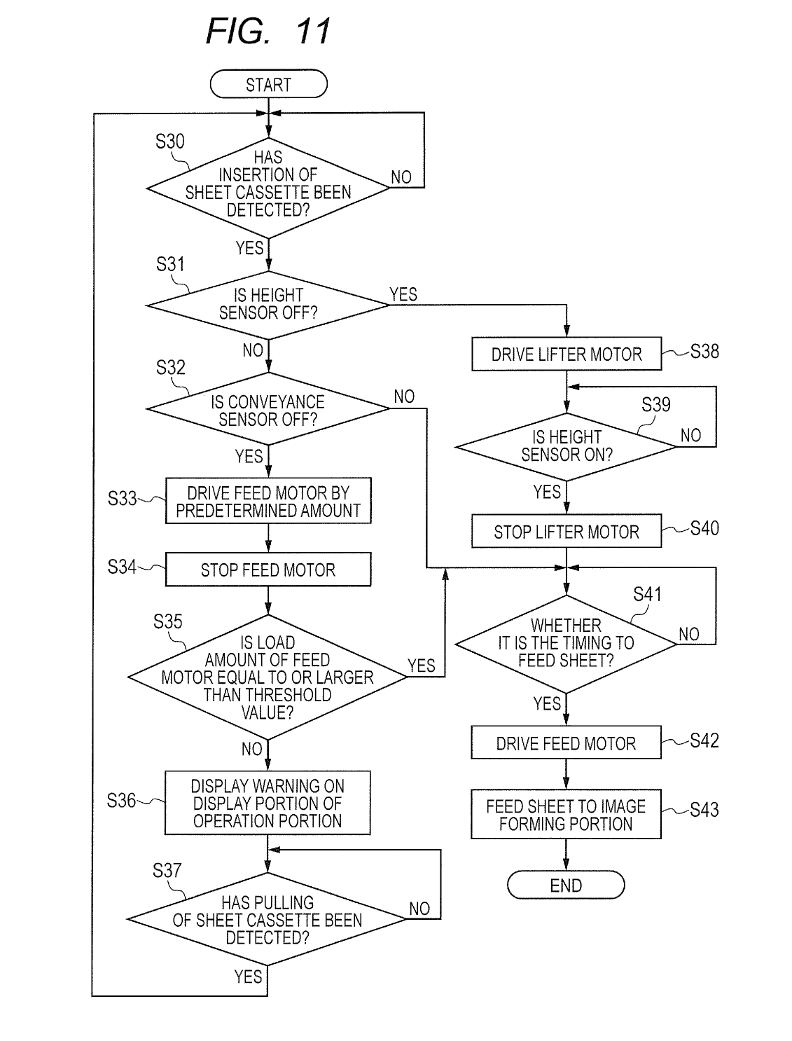

Next, a description will be provided of a control sequence of the second embodiment at the time when a user inserts the sheet cassette 5 to the sheet feeding apparatus 230. FIG. 11 is a flowchart for illustrating the control sequence at the time when the sheet cassette 5 is inserted into the sheet feeding apparatus 230. The processes illustrated in FIG. 11 are activated when the instruction to start the image forming operation is given, and are executed by the control portion 260.

The processes in S30 and S31 are the same as the processes in S10 and S11 in FIG. 8 of the first embodiment, and hence description thereof is omitted. Further, the processes in S38 to S43, which are executed when the height sensor 12 is in the OFF state in S31, are the same as the processes in S18 to S23 in FIG. 8 of the first embodiment, and hence description thereof is omitted. When the conveyance sensor 22 is in the OFF state in S32, the control portion 260 causes the process to proceed to S33. Meanwhile, when the conveyance sensor 22 is in the ON state, the control portion 260 causes the process to proceed to S41.

In S33, the control portion 260 drives the feed motor M1 via the motor control portion 157 for a predetermined time period, to thereby rotate the pickup roller 1, the feed roller 2, and the retard roller 3 by a predetermined amount. Through rotation of the pickup roller 1, the sheet P is conveyed in the conveyance direction. As a rotation amount of the pickup roller 1 becomes larger, a length of a projecting part of the sheet P from the sheet cassette 5 becomes larger. As a result, when a user pulls out the sheet cassette 5, the projecting part of the sheet P from the sheet cassette 5 may be caught on a side wall of the sheet feeding apparatus 230 to buckle the sheet P. The rotation amount of the pickup roller is set as low as possible so as to prevent buckling and breakage of the sheet P as described above. Further, at the time of startup of the feed motor M1 being the stepper motor, a detection error of the current value of the drive control device 516 by the current detecting portions 507 and 508 is large. Therefore, a time period (predetermined time period) for which the pickup roller 1 is rotated by the predetermined amount needs to be set larger than a time period required to ensure accuracy of detecting the current by the current detecting portions 507 and 508 from the startup of the motor M1. Consequently, the control portion 260 can acquire a current value with a small detection error, thereby being capable of accurately determining the load amount (load torque amount) of the motor M1.

After that, in S34, the control portion 260 stops the drive of the motor M1 via the motor control portion 157, to thereby stop the rotation of the pickup roller 1, the feed roller 2, and the retard roller 3. Then, in S35, the control portion 260 determines the amount of the torque applied to the rotor of the motor M1 based on the current value iq acquired in the process in S33 from the drive control device 516 configured to control the drive of the motor M1. Specifically, the control portion 260 determines the torque amount based on the table stored in the storage portion 261 described above. When the determined torque amount is equal to or larger than the threshold value, the control portion 260 causes the process to proceed to S41, and when the determined torque amount is smaller than the threshold value, the control portion 260 causes the process to proceed to S36. The processes in S36, S37, and S38 are the same processes as those in S16, S17, and S18 in FIG. 8 of the first embodiment, and hence description thereof is omitted.

A reason of determining whether or not the conveyance sensor 22 is in the OFF state in the process in S32 is to prevent a situation that, when the sheet cassette 5 is inserted and pulled out successively for a plurality of times, the sheet P is gradually conveyed for that period. In the first embodiment, the load amount of the motor M1 is measured during the image forming operation. For example, in the configuration of the sheet feeding apparatus 230 according to the first embodiment, an insertion situation of the sheet cassette may be determined through the following control. That is, after the operation of feeding the sheet is performed one time, only when first insertion of the sheet cassette after the sheet cassette 5 is drawn is detected, as in the second embodiment, the motor M1 may be rotated by a predetermined amount to determine an insertion situation of the sheet cassette based on the load amount of the motor M1.

Further, in the first and second embodiments described above, as a unit configured to measure the load of the motor M1, a configuration based on the detection of the current value by the current detecting portions 507 and 508 of the drive control device 516 is described. For example, a voltage detecting portion is provided in place of the current detecting portions 507 and 508, a voltage is measured by the voltage detecting portion, and a current value is calculated based on the measured voltage. In this manner, a load may be detected based on the calculated current value. Further, for example, a torquemeter (torque transducer) is connected to a shaft of the pickup roller 1, and torque that is output so as to rotate the pickup roller 1 is directly measured. In this manner, a load may be determined based on the measured torque amount.

As described above, according to the first and second embodiments, the operation of feeding the sheet can be prevented from being performed in the state in which the pickup roller is not held in contact with the sheet.

In the first embodiment and second embodiments, the operation of feeding the sheet is controlled based on the load torque applied to the rotor. However, for example, the operation of feeding the sheet may be controlled based on the current value iq in the rotating coordinate system. That is, the operation of feeding the sheet is performed when the current value iq being a value indicating a torque current component in the rotating coordinate system is equal to or larger than a predetermined value (predetermined threshold value), and the operation of feeding the sheet is not performed when the current value iq is smaller than the predetermined value (predetermined threshold value). Further, the operation of feeding the sheet may be controlled based on the current values iα and iβ in the stationary coordinate system instead of the current value iq in the rotating coordinate system.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-015665, filed Jan. 31, 2017, which is hereby incorporated by reference herein in its entirety.

What is claimed is:

1. A sheet feeding apparatus configured to feed a sheet, the sheet feeding apparatus comprising:
a containing portion including a tray on which the sheet is stacked, the containing portion being configured to be removable from the sheet feeding apparatus;
a pickup roller configured to be brought into abutment against and separated from the sheet stacked on the tray and configured to feed the sheet in a state in which the pickup roller abuts against the sheet;
a support portion configured to cause the pickup roller to fall so that the pickup roller is brought into abutment against the sheet contained in the tray when a far-side end of the containing portion reaches a predetermined position in the sheet feeding apparatus;
a detector provided upstream of the predetermined position in an insertion direction in which the containing portion is inserted, the detector being configured to detect the containing portion;
a motor configured to drive the pickup roller; and
a controller configured to control an operation of feeding the sheet by the pickup roller,
wherein, during a period in which the pickup roller is driven in a state in which the detector detects the containing portion, the controller allows the operation of feeding the sheet when an amount of a load torque that is applied to a rotor of the motor is equal to or larger than a predetermined value and the controller inhibits the operation of feeding the sheet when the amount of the load torque is smaller than the predetermined value.

2. A sheet feeding apparatus according to claim 1, further comprising:
a phase determiner configured to determine a rotation phase of the rotor of the motor; and
a current detector configured to detect a current value of a drive current flowing through a winding of the motor,
wherein the controller controls the drive current so that a difference between a command phase indicating a target phase of the rotor of the motor and the rotation phase determined by the phase determiner becomes smaller, and
wherein the amount of the load torque is determined based on the current value of the drive current which is detected by the current detector.

3. A sheet feeding apparatus according to claim 2, wherein the controller controls the drive current based on a torque current component for causing the rotor to generate torque, the torque current component being expressed in a rotating coordinate system based on the rotation phase determined by the phase determiner, so that the difference becomes smaller, and the amount of the load torque is determined based on a value of the torque current component of the drive current detected by the current detector.

4. A sheet feeding apparatus according to claim 1, further comprising:
a current detector configured to detect a current value of a drive current flowing through the motor; and
a phase determiner configured to determine a rotation phase of the rotor,
wherein the controller controls the drive current based on a torque current component for causing the rotor to generate torque, the torque current component being expressed in a rotating coordinate system based on the rotation phase determined by the phase determiner, so that a difference between a command phase indicating a target phase of the rotor of the motor and the rotation phase determined by the phase determiner becomes smaller, and
wherein the controller performs the operation of feeding the sheet when a value of the torque current component of the drive current detected by the current detector, which is a value corresponding to the amount of the load torque, is equal to or larger than a predetermined threshold value, and the controller inhibits the operation of feeding the sheet when the value of the torque current component is smaller than the predetermined threshold value.

5. A sheet feeding apparatus according to claim 2, further comprising a conveyance roller provided downstream of the pickup roller in a conveyance direction in which the sheet is conveyed, the conveyance roller being configured to convey the sheet fed by the pickup roller in the conveyance direction,
wherein the containing portion includes a pivotal movement regulating member configured to pivotally move the support portion,
wherein the support portion pivotally moves about a rotation axis of the conveyance roller when the containing portion is inserted into the sheet feeding apparatus so that the pivotal movement regulating member reaches a first position, and
wherein the pickup roller is brought into abutment against the sheet stacked on the tray when the support portion pivotally moves.

6. A sheet feeding apparatus according to claim 5, further comprising:
a raising and lowering device configured to raise and lower an end portion of the tray on a downstream side in a feed direction of the sheet stacked on the tray; and
a support portion detector configured to detect the support portion,
wherein, in the state in which the detector detects the containing portion, when the support portion detector does not detect the support portion, the controller controls the raising and lowering device so as to raise the tray until the support portion detector detects the support portion, and, when the support portion detector detects the support portion, the controller inhibits the tray from being raised.

7. A sheet feeding apparatus according to claim 5, wherein the controller controls so as to:
start drive of the pickup roller at a timing to feed the sheet;
detect whether or not the pivotal movement regulating member is positioned upstream of the first position in the insertion direction based on the amount of the load torque that is applied to the rotor of the motor by a rotation of the pickup roller;
stop the drive of the pickup roller when the pivotal movement regulating member is positioned upstream of the first position in the insertion direction; and
continue the drive of the pickup roller when the pivotal movement regulating member is not positioned upstream of the first position in the insertion direction.

8. A sheet feeding apparatus according to claim 5, wherein the controller controls so as to:
drive the pickup roller for a predetermined time period before a timing to feed the sheet;
detect whether or not the pivotal movement regulating member is positioned upstream of the first position in the insertion direction based on the amount of the load torque that is applied to the rotor of the motor during a period in which the pickup roller is driven for the predetermined time period;
prevent drive of the pickup roller when the pivotal movement regulating member is positioned upstream of the first position in the insertion direction; and
start the drive of the pickup roller when the pivotal movement regulating member is not positioned upstream of the first position in the insertion direction.

9. A sheet feeding apparatus according to claim 8, wherein the predetermined time period is longer than a time period required for the current detector to ensure accuracy of detecting the drive current after the controller starts drive of the motor.

10. A sheet feeding apparatus according to claim 1, further comprising:
a speed determiner configured to determine a rotation speed of the rotor of the motor; and
a current detector configured to detect a current value of a drive current flowing through a winding of the motor,
wherein the controller controls the drive current so that a difference between a command speed indicating a target speed of the rotor of the motor and the rotation speed determined by the speed determiner becomes smaller, and
wherein the amount of the load torque is determined based on the current value of the drive current which is detected by the current detector.

11. A sheet feeding apparatus according to claim 10, further comprising a conveyance roller provided downstream of the pickup roller in a conveyance direction in which the sheet is conveyed, the conveyance roller being configured to convey the sheet fed by the pickup roller in the conveyance direction,
wherein the containing portion includes a pivotal movement regulating member configured to pivotally move the support portion,
wherein the support portion pivotally moves about a rotation axis of the conveyance roller when the containing portion is inserted into the sheet feeding apparatus so that the pivotal movement regulating member reaches a first position, and
wherein the pickup roller is brought into abutment against the sheet stacked on the tray when the support portion pivotally moves.

12. A sheet feeding apparatus according to claim 11, further comprising:
a raising and lowering device configured to raise and lower an end portion of the tray on a downstream side in a feed direction of the sheet stacked on the tray; and
a support portion detector configured to detect the support portion,
wherein, in the state in which the detector detects the containing portion, when the support portion detector does not detect the support portion, the controller controls the raising and lowering device so as to raise the tray until the support portion detector detects the support portion, and, when the support portion detector detects the support portion, the controller inhibits the tray from being raised.

13. A sheet feeding apparatus according to claim 11, wherein the controller controls so as to:
start drive of the pickup roller at a timing to feed the sheet;
detect whether or not the pivotal movement regulating member is positioned upstream of the first position in the insertion direction based on the amount of the load torque that is applied to the rotor of the motor by a rotation of the pickup roller;
stop the drive of the pickup roller when the pivotal movement regulating member is positioned upstream of the first position in the insertion direction; and
continue the drive of the pickup roller when the pivotal movement regulating member is not positioned upstream of the first position in the insertion direction.

14. A sheet feeding apparatus according to claim 11, wherein the controller controls so as to:
drive the pickup roller for a predetermined time period before a timing to feed the sheet;
detect whether or not the pivotal movement regulating member is positioned upstream of the first position in the insertion direction based on the amount of the load torque that is applied to the rotor of the motor during a period in which the pickup roller is driven for the predetermined time period;
prevent drive of the pickup roller when the pivotal movement regulating member is positioned upstream of the first position in the insertion direction; and
start the drive of the pickup roller when the pivotal movement regulating member is not positioned upstream of the first position in the insertion direction.

15. A sheet feeding apparatus according to claim 14, wherein the predetermined time period is longer than a time period required for the current detector to ensure accuracy of detecting the drive current after the controller starts drive of the motor.

16. An image forming apparatus, comprising:
an image forming portion configured to form an image on a sheet; and
a sheet feeding apparatus configured to feed the sheet to the image forming portion, the sheet feeding apparatus including:
a containing portion including a tray on which the sheet is stacked, the containing portion being configured to be removable from the sheet feeding apparatus;
a pickup roller configured to be brought into abutment against and separated from the sheet stacked on the tray and configured to feed the sheet in a state in which the pickup roller abuts against the sheet;
a support portion configured to cause the pickup roller to fall so that the pickup roller is brought into abutment against the sheet contained in the tray when a far-side end of the containing portion reaches a predetermined position in the sheet feeding apparatus;
a detector provided upstream of the predetermined position in an insertion direction in which the containing portion is inserted, the detector being configured to detect the containing portion;
a motor configured to drive the pickup roller; and
a controller configured to control an operation of feeding the sheet by the pickup roller,
wherein, during a period in which the pickup roller is driven in a state in which the detector detects the containing portion, the controller allows the operation of feeding the sheet when an amount of a load torque that is applied to a rotor of the motor is equal to or larger than a predetermined value and the controller inhibits the operation of feeding the sheet when the amount of the load torque is smaller than the predetermined value.

17. An image forming apparatus according to claim 16, wherein the sheet feeding apparatus further includes a conveyance roller provided downstream of the pickup roller in a conveyance direction in which the sheet is conveyed, the conveyance roller being configured to convey the sheet fed by the pickup roller in the conveyance direction,
wherein the containing portion includes a pivotal movement regulating member configured to pivotally move the support portion,
wherein the support portion pivotally moves about a rotation axis of the conveyance roller when the containing portion is inserted into the sheet feeding apparatus so that the pivotal movement regulating member reaches a first position, and
wherein the pickup roller is brought into abutment against the sheet stacked on the tray when the support portion pivotally moves.

18. An image forming apparatus according to claim 17, further comprising a display portion configured to display information indicating that the containing portion is not properly inserted into the sheet feeding apparatus when the pivotal movement regulating member is positioned upstream of the first position in the insertion direction.
